(19) United States
(12) Patent Application Publication
(10) Pub. No.: US 2008/0241788 A1
(43) Pub. Date: Oct. 2, 2008

(54) METHOD FOR THE MANUFACTURE OF DENTAL PROSTHESES

(75) Inventors: Jochen Bauer, Rielasingen (DE); Angela Klaus, Hanau (DE); Rudi Steinke, Hanau (DE); Lars Weisensel, Johannesberg (DE)

Correspondence Address: DENNISON, SCHULTZ & MACDONALD, 1727 KING STREET, SUITE 105, ALEXANDRIA, VA, 22314, US

(73) Assignee: Degudent GmbH, Hanau (DE)

(21) Appl. No.: 12/045,146

(22) Filed: Mar. 10, 2008

(30) Foreign Application Priority Data
Mar. 19, 2007 (EP) 07 10 4431.7

(51) Int. Cl. A61C 13/00; C22C 19/07; B23K 26/02

(52) U.S. Cl. 433/167; 420/437; 219/121.61

(57) ABSTRACT

The invention relates to the use of a cobalt-chromium alloy in the manufacture of a dental prosthesis. The alloy contains:
43-68% by weight cobalt,
12-30% by weight chromium,
8-25% by weight tungsten,
0-13% by weight iron,
0-30% by weight manganese,
0-10% by weight molybdenum,
0-5% by weight of at least one of the elements
aluminum, tantalum, rhenium, titanium and less than 0.1% by weight carbon.

A dental prosthesis with favorable workability and a low corrosion rate is obtained by manufacturing the dental prosthesis by means of a laser melting and/or sintering process.

### BACKGROUND OF THE INVENTION

The invention relates to the use of a cobalt-chromium alloy in the manufacture of dental prostheses. The invention also relates to a method for the manufacture of dental prostheses.

For the purpose of economically manufacturing dental prostheses of any geometry with high precision, it is known to produce dental prostheses by means of a laser melting or sintering process. For this, a method can be employed that is fundamentally known from DE-C-1 96 49 865. The manufacturing is carried out by applying successive layers of a powder-form material onto a substrate, whereby each layer is heated by a focussed laser beam prior to the application of the following layer in such a manner that it bonds to the powder layer below.

From EP-A-1 568 472 a freeform melting and/or freeform sintering can be obtained for the manufacture of dental products. For this, a laser or electron beam is guided in such a manner that positions of the respective workpiece layer to be formed are irradiated repeatedly to reduce the overall manufacturing time.

From DE-C-33 19 457 there is known a cobalt-chromium alloy intended as fusing casting alloy for a fixed or removable dental prosthesis. This alloy should possess a hardness value of less than 300 (HV 5) after the thermal treatment required for the ceramic veneering. The alloy comprises 42-69.5% by weight cobalt, 10-35% by weight chromium, and 5-25% by weight tungsten. The alloy additionally contains 2-10% by weight iron, 1-4% by weight aluminum, 0-5% by weight rhenium, and 0-2% by weight titanium, whereby the sum total of the amounts of chromium, tungsten, and rhenium is at least 27.5% by weight and at most 45% by weight, and the sum total of titanium and aluminum is at most 5% by weight. Trials with this alloy have shown that it is not sufficiently free flowing, so that filigree areas of a framework can not be produced. The reason for this is that the aluminum oxidizes and the resulting oxide film inhibits free flow. Also of disadvantage is the formation of intermetallic cobalt-aluminum phases, which negatively affect hardness. Moreover, the alloy exhibits a corrosion rate of approximately 65 μg/cm² in 7 days, measured in accordance with DIN 22674. This corrosion rate according to DIN 22674 is certainly permitted for use in the field of dental technology, but fundamentally does not satisfy the requirements of the manufacturers of alloys employed in the dentistry field. Rather, one endeavours to employ alloys that possess corrosion rates on the order of magnitude of those of noble metal alloys, i.e. below 10 μg/cm² in 7 days. Due to these negative characteristics of the above-mentioned cobalt-chromium alloys, these alloys were not used for practical applications.

A further cobalt-chromium alloy can be obtained from EP-A-1 696 044. This alloy does not contain any aluminum but contains gallium in a proportion of between 2 and 4% by weight.

A dental casting alloy in accordance with WO-A-2004/042098 contains 25-32% by weight chromium, 8-12% by weight tungsten, 0.05-0.4% by weight each of one or several elements in the 4^{th} and/or 5^{th} subgroup of the periodic table, some manufacturing-related contamination, and cobalt as the remainder.

Subject matter of DE-A-1 98 15 091 is an alloy for casting dental parts, which comprises 20-35% by weight chromium, 4-8% by weight molybdenum, up to 3% by weight silicon, 0.05-1.2% by weight tantalum, niobium and/or tungsten, whereby the proportion of each individual element tantalum, niobium or tungsten is less than 0.5% by weight, up to 0.3% by weight carbon, 0.05-0.4% by weight nitrogen, up to 3% by weight iron, up to 3% by weight manganese, less than 1% by weight in possible contaminations, with cobalt constituting the remainder.

If cobalt-chromium alloys are used for the manufacture of dental prostheses by means of freeform melting and/or freeform sintering, one exclusively employs those alloys that have excelled as casting alloys in practical applications. Other alloys known in the literature are not employed owing to the assumption that negative characteristics will be reinforced by laser sintering and/or laser melting. Moreover, it was assumed that dental prostheses produced from cobalt-chromium materials through laser sintering or laser melting have a strong tendency for distortions, so that consequently necessary thermal treatment steps would lead to embrittlement, which in turn results in a greatly lower strain at failure. It was also assumed that this would lead to extremely high hardness values, which are a disadvantage in mechanical finishing work.

### SUMMARY OF THE INVENTION

The present invention is based on the objective to provide a cobalt-chromium alloy dental prosthesis with favourable workability characteristics. The breaking tendency should be minimized while achieving hardness values that allow problem-free finishing. It is also intended to achieve corrosion rates similar to those of noble metals.

### DETAILED DESCRIPTION OF THE INVENTION

The objective of the invention is met by the invention through the use of a cobalt-chromium alloy comprising
43-68% by weight cobalt,
12-30% by weight chromium,
8-25% by weight tungsten,
0-13% by weight iron,
0-30% by weight manganese,
0-10% by weight molybdenum,
0-5% by weight of at least one of the elements
aluminum, tantalum, rhenium, titanium, and less than 0.1% by weight carbon for the manufacture of dental prostheses by means of a laser melting and/or laser sintering process.

Preferably, the cobalt-chromium alloy contains aluminum in an amount of between 0.5 and 5% by weight.

In particular it is intended that the cobalt-chromium alloy contain 50-65% by weight cobalt, 15-22% by weight chromium, 15-22% by weight tungsten, 3-11% by weight iron, and 1-3% by weight aluminum.

Preferably, the cobalt-chromium alloy contains 50-60% by weight cobalt, 15-22% by weight chromium, 15-22% by weight tungsten, 4-10% by weight iron, and 1-3% by weight aluminum.

Surprisingly, the cobalt-chromium alloy of the above-mentioned composition, which is not used for practical applications, has led to a dental prosthesis, manufactured using a laser melting and/or laser sintering process, i.e. by freeform melting or sintering, that exhibits failure strain characteristics equal to those known for casting alloys. But surprisingly at the same time one obtains a corrosion rate of less than 10 μg/cm² in 7 days, measured in accordance with DIN 22674, which is more than 6 times lower than the corrosion rate of a dental casting alloy of equal composition.

The corrosion rate in accordance with DIN 22674 is determined by exposing a lamina of the alloy—manufactured through casting or by a laser melting and/or laser sintering process—to a test solution conforming to ISO 10271, so that subsequently the quantity of material leached out of the lamina is determined after 7 days, whereby the surface area of the lamina is known.

Besides the excellent resistance to corrosion, the favourable mechanical characteristics are also surprising. Both of these can possibly be explained by the kinetics of the intermetallic phases being affected by laser melting or laser sintering in such a way that, in contrast to a casting process, the phases can not develop sufficiently for the resulting negative characteristics to become noticeable.

Furthermore, a dental prosthesis is obtained which, prior to a subsequent thermal treatment, exhibits a hardness of less than 350 (HV 10), allowing adequate finishing work. However, if a thermal treatment is required to compensate for distortions, measurements have shown that even though the hardness will rise above 400 (HV 10), problem-free finishing work will still be possible, which is a characteristic that could not be anticipated.

The positive characteristics of the dental prosthesis or framework develop in particular if the manufacture is carried out using laser melting, i.e. if the individual powder layers are successively applied by melting. Onto each melted and subsequently solidified layer a further powder layer is applied, which subsequently also is melted and thus joined to the layer below. These processing steps are carried out successively to obtain, via freeform melting, the desired geometry of the dental prosthesis or framework to be manufactured.

As a further development, the cobalt-chromium alloy can additionally contain 0-0.2% by weight of at least one of the elements boron, yttrium, 0-2% by weight of at least one of the elements vanadium, silicon, copper, zinc, niobium, 0-10% by weight gallium, 0-5% by weight germanium, and 0-1% by weight of at least one of the elements cerium, lanthanum.

Irrespective of this, the sum total of chromium, tungsten, and rhenium and/or aluminum should not exceed 50% by weight. In particular, the ratio of chromium:tungsten+rhenium should be between approximately 2:3 and approximately 2:1 or rather between approximately 2:3 and approximately 3:2.

Furthermore, the content of chromium+tungsten should be at least 30% by weight and at most 50% by weight and the chromium:tungsten ratio should be between approximately 3:4 and approximately 4:3.

However, the invention is also characterized by a method for the manufacture of a dental prosthesis by a layered build-up of powder of a chromium-cobalt alloy, whereby several powder layers are applied in succession and—prior to application of the subsequent powder layer—each powder layer is heated in a predetermined area—corresponding to a selected cross-sectional area of the dental prosthesis to be manufactured—by a focussed laser beam to a predetermined temperature, so that the powder layer is fused to the powder layer below by a melting and/or sintering of the powder layer, and is characterized by the use of a cobalt-chromium alloy with
43-68% by weight cobalt,
12-30% by weight chromium,
8-25% by weight tungsten,
0-13% by weight iron,
0-30% by weight manganese,
0-10% by weight molybdenum,
0-5% by weight of at least one of the elements
aluminum, tantalum, rhenium, titanium,
and less than 0.1% by weight carbon.

In this, it is in particular intended that the dental prosthesis after its manufacture through the laser melting and/or laser sintering process be provided with a ceramic or plastic veneering without a preceding thermal treatment.

It has surprisingly been found that, when using a corresponding cobalt-chromium alloy, the dental prosthesis produced by means of a freeform sintering or melting process possesses a hardness usually associated with cast alloys, in each case prior to veneering. Disadvantages with respect to any distortion tendencies do not exist.

Furthermore, it can be ascertained that the use of the cobalt-chromium alloy in accordance with the invention without thermal treatment prior to or after the laser melting or sintering process produces distortion-free frameworks with a hardness value typical of cast materials and adequate ductility even after the veneering.

In particular, it is intended that the cobalt-chromium alloy additionally contains 0-0.2% by weight of at least one of the elements boron, yttrium, 0-2% by weight of at least one of the elements vanadium, silicon, copper, zinc, niobium, 0-10% by weight gallium, 0-5% by weight germanium, and 0-1% by weight of at least one of the elements cerium, lanthanum. The alloy should then not contain more than 50% by weight of chromium, tungsten, and rhenium and/or aluminum. The invention is further characterized by the ratio of chromium:tungsten+rhenium being between approximately 2:3 and approximately 2:1 or rather between approximately 2:3 and approximately 3:2.

In accordance with an embodiment of the invention, the content of chromium+tungsten is at least 30% by weight and at most 40% by weight and the chromium:tungsten ratio is between approximately 3:4 and approximately 4:3.

In particular, the alloy can contain 50-65% by weight cobalt, 15-22% by weight chromium, 15-22% by weight tungsten, 4-11% by weight iron, and 1-3% by weight aluminium.

The invention is also characterized by a dental prosthesis, which consists of a cobalt-chromium alloy, is manufactured by means of a laser melting and/or laser sintering processes, and possesses a hardness HV (HV10)<350 without being subjected to a thermal treatment prior to the veneering.

Surprisingly, it has been found that the hardness of a dental prosthesis according to the invention, such as a framework, increases (Values greater than 400 (HV10)) if thermal treatment is carried out prior to veneering. Tensile strength and tensile yield strength increase as well. But despite the increase in hardness no problems were faced in the finishing work. No additional noticeable hardness increase could be detected in the subsequent veneering of the dental prosthesis or the framework.

What is claimed is:

1. A cobalt-chromium alloy, comprising
43-68% by weight cobalt,
12-30% by weight chromium,
8-25% by weight tungsten,
0-13% by weight iron,
0-30% by weight manganese,
0-10% by weight molybdenum,
0-5% by weight of at least one of the elements
aluminum, tantalum, rhenium, titanium and less than 0.1% by weight of carbon for the manufacture of dental prostheses by means of a laser melting and/or laser sintering process.

2. The cobalt-chromium alloy of claim 1, characterized in that the proportion of aluminum is 0.5-5% by weight.

3. The cobalt-chromium alloy of claim 1, with 50-65% by weight cobalt, 15-22% by weight chromium, 15-22% by weight tungsten, 3-11% by weight iron, and 1-3% by weight aluminum.

4. The cobalt-chromium alloy of claim 1, with 50-60% by weight cobalt, 15-22% by weight chromium, 15-22% by weight tungsten, 4-10% by weight iron, and 1-3% by weight aluminum.

5. The cobalt-chromium alloy of claim 1, which additionally contains 0-0.2% by weight of at least one of the elements boron, yttrium, 0-2% by weight of at least one of the elements vanadium, silicon, copper, zinc, niobium, 0-10% by weight gallium, 0-5% by weight germanium, and 0-1% by weight of at least one of the elements cerium, lanthanum.

6. The cobalt-chromium alloy of claim 1, in which the sum total amount of chromium, tungsten, and rhenium and/or aluminum does not exceed 50% by weight.

7. The cobalt-chromium alloy of claim 1, in which the chromium:tungsten+rhenium ratio is between approximately 2:3 and approximately 2:1 or rather between approximately 2:3 and approximately 3:2.

8. The cobalt-chromium alloy of claim 1, in which the content of chromium+tungsten is at least 30% by weight and at most 50% by weight and the chromium:tungsten ratio is between approximately 3:4 and approximately 4:3.

9. The cobalt-chromium alloy of claim 1, for the manufacture of a dental prosthesis that is veneered without prior annealing.

10. A method for the manufacture of a dental prosthesis by layer-by-layer build-up from powder of a chromium-cobalt alloy, in which several powder layers are successively applied on top of each other and each powder layer, prior to the application of the subsequent powder layer, is heated in selected areas, corresponding to the cross-sectional area of the dental prosthesis to be manufactured, by a focussed laser beam to a predetermined temperature in such a manner that the powder layer is attached to the powder layer below by melting and/or sintering of the powder layer,
the employed cobalt-chromium alloy comprising
43-68% by weight cobalt,
12-30% by weight chromium,
8-25% by weight tungsten,
0-13% by weight iron,
0-30% by weight manganese,
0-10% by weight molybdenum,
0-5% by weight of at least one of the elements
aluminum, tantalum, rhenium, titanium and less than 0.1% by weight carbon.

11. The method of claim 10, characterized in that the proportion of aluminum is 0.5-5% by weight.

12. The method of claim 10, characterized in that the alloy contains 50-65% by weight cobalt, 15-22% by weight chromium, 15-22% by weight tungsten, 4-11% by weight iron, and 1-3% by weight aluminum.

13. The method of claim 10, characterized in that the alloy contains 50-60% by weight cobalt, 15-22% by weight chromium, 15-22% by weight tungsten, 4-10% by weight iron, and 1-3% by weight aluminum.

14. The method of claim 10, characterized in that the cobalt-chromium alloy additionally contains 0-0.2% by weight of at least one of the elements boron, yttrium, 0-2% by weight of at least one of the elements vanadium, silicon, copper, zinc, niobium, 0-10% by weight gallium, 0-5% by weight germanium, and 0-1% by weight of at least one of the elements cerium, lanthanum.

15. The method of claim 10, characterized in that the alloy does not contain more than 50% by weight of chromium, tungsten, and rhenium and/or aluminum.

16. The method of claim 10, characterized in that the chromium:tungsten+rhenium ratio ranges between approximately 2:3 and approximately 2:1 or rather between approximately 2:3 and approximately 3:2.

17. The method of claim 10, characterized in that the content of chromium+tungsten is at least 30% by weight and at most 50% by weight, and that the chromium tungsten ratio is between approximately 3:4 and approximately 4:3.

18. The method of claim 10, characterized in that the dental prosthesis or its framework is produced by means of a laser melting process.

19. The method of claim 10, characterized in that the manufactured dental prosthesis is veneered without prior annealing.

20. Framework for a dental prosthesis manufactured by means of a laser melting and/or laser sintering process from a cobalt-chromium alloy in accordance with claim 1, whereby the framework exhibits a corrosion rate of less than 10 μg/cm² in 7 days.

21. A dental prosthesis produced from a cobalt-chromium alloy by means of a laser melting and/or laser sintering process, which without veneering and without prior thermal treatment exhibits a hardness (HV10)<350, whereby the cobalt-chromium alloy possesses a composition in accordance with claim 1.
